(19) United States
(12) Patent Application Publication
(10) Pub. No.: US 2005/0069606 A1
(43) Pub. Date: Mar. 31, 2005

(54) SPARKLING LOW ALCOHOLIC BEVERAGE SAKE AND PRODUCING METHOD THEREOF

(76) Inventors: AKITSUGA NINJOUJI, MIYAGI (JP); TOMOKO TAKEKAWA, MIYAGI (JP); YASUKO HOSHI, MIYAGI (JP); TOMOKO KIKUCHI, MIYAGI (JP)

Correspondence Address: TOWNSEND & BANTA;c/o PORTFOLIO IP, PO BOX 52050, MINNEAPOLIS, MN, 55402, US

(21) Appl. No.: 09/437,111

(22) Filed: Oct. 16, 2001

(30) Foreign Application Priority Data
Dec. 29, 1998 (JP) 10-377643

(51) Int. Cl. C12C 11/00

(52) U.S. Cl. 426/11

(57) ABSTRACT

Sparkling low alcoholic beverage sake having light turbid, high transparent, refreshing and superior flavored properties, and the producing method thereof are provided. Steamed rice and malted rice (koji) are saccharified and fermented in the presence of multiple acids to produce low alcoholic unrefined sake (moromi). A part of the unrefined sake (moromi) is filtered through coarse mesh filter to separate turbid liquid containing yeast and having fermentation activity. The other part of unrefined sake (moromi) is pressed to separate clear transparent liquid. The turbid liquid and the clear transparent liquid are mixed and blended, then bottled. When the inner gas pressure in the bottle reaches 2-5 kg/cm², the fermentation is terminated.

### BACKGROUND OF THE INVENTION

1. Field of the Invention

This invention relates to sparkling low alcoholic beverage sake with low turbidity and high transparency and producing method thereof.

2. Description of the Prior Art

Japanese sake manufacturing industry is called as mature industry. Long time has passed since consumers, especially young generation, were said to be weaned from sake, and the condition with no growth of consumption is seen. For overthrowing such condition, the sake industry and trade tried to diversify their marketing products and to create demands for increasing consumption.

Under such circumstances, conventional prior known method of producing sparkling beverage sake is known, e.g. Japanese Patent Laid-Open No. 61-47179 and Japanese Patent Publication No. 7-79674. Namely, after unrefined sake (moromi) is roughly filtered, the filtrate was packed in the sealed vessel and fermented. At the time of the inner gas pressure reaches the constant pressure, the fermentation is terminated to produce sparkling beverage sake.

For example, Japanese Patent Publication No. 3-11758 also discloses method of producing the conventional low alcoholic beverage sake. The disclosure is that saccharification and fermentation are proceeded in the presence of multiple acids, and the fermentation is terminated in the low alcoholic concentration. The thus produced unfiltered sake is stored in the vessel to produce low alcoholic beverage sake.

### SUMMARY OF THE INVENTION

The conventional prior known sparkling beverage sake has turbid color, i.e. unrefined or crude sake, consequently, image of pure clear sake is lost, furthermore the conventional low alcoholic beverage sake has no clear refreshing images of traditional Japanese sake.

The present invention has been completed by considering the prior disadvantages. It is an object of the present invention to provide sparkling low alcoholic beverage sake having low turbidity, high transparency, refreshed feeling and superior flavor. It is another object of the present invention to provide a method of producing sparkling low alcoholic beverage sake.

In order to attain the objects, a method of producing sparkling low alcoholic beverage sake is characterized by comprising saccharifying and fermenting steamed rice and malted rice (koji) in the presence of multiple acids, filtering a part of low alcoholic unrefined sake (moromi) with a coarse mesh filter or centrifuging the same to separate turbid liquid having fermentation activity containing yeast, separating the clear liquid from the other part of the above unrefined sake (moromi) by compressed filtration, blending the above turbid liquid and the above clear liquid in a vessel and airtightly sealed within the vessel.

According to the method of producing sparkling low alcoholic beverage sake according to the present invention it is preferable that, the fermentation is terminated when inner gas pressure by fermentation reaches at 2-5 kg/cm², after the sealing in the vessel.

According to the method of producing sparkling low alcoholic beverage sake according to the present invention it is preferable that, pasteurization is conducted when the liquid having alcoholic concentration 4-6%, Japanese sake scaling between −70 and −90, and acidity 3-4, after the sealing in the vessel.

According to the method of producing sparkling low alcoholic beverage sake of the present invention it is preferable that said fermentation liquid is filtered within the closed system and the clear filtrate is sealed within the vessel when the said turbid liquid and the said clear liquid are blended and fermented in the sealed tank, and the fermented liquid in the said sealed tank reaches alcoholic concentration 4-6%, Japanese sake scaling between −70 and −90, and acidity 3-4 and inner gas pressure in the said sealed tank at 2-5 kg/cm².

According to the fifth aspect of the present invention, the method of producing the sparkling low alcoholic beverage sake of the present invention is preferably to store at below 0° C. or pasteurize after sealing in the vessel in order to keep fresh flavor. In the present invention, carbon dioxide can be compressed into the clear filtrate of the sparkling low alcoholic beverage sake, which is then bottled. Thereby, it becomes easy to adjust the volume of the carbon dioxide.

According to the sixth aspect of the present invention, the sparkling low alcoholic beverage sake in the sealed vessel comprising having inner gas pressure of vessel 2-5 kg/cm², alcohol concentration 4-6%, Japanese sake scaling between −70 and −90, acidity 3-4 and absorbancy at 660 nm between 0 and 2.0 is provided.

The sparkling low alcoholic beverage sake of the present invention can be produced according to the method of producing the sparkling low alcoholic beverage sake of the present invention by using filter of 160-210 mesh.

According to the seventh aspect of the present invention, the sparkling low alcoholic beverage sake according to this invention wherein the absorbancy at 660 nm is preferably in the range between 0 and 0.01, is provided.

### BRIEF DESCRIPTION OF THE DRAWING

FIG. 1 is a schematic illustration of the plant used in the method of producing the sparkling low alcoholic beverage sake in embodiment 2 of the present invention.

### DETAILED DESCRIPTION OF THE PREFERRED EMBODIMENTS

In the present invention, saccharification and fermentation can, if necessary, separately proceed. In the invention, “in the presence of multiple acids” is referred to as a condition that acidity exceeds 3.5 at least one moment in the process during stage of unrefined sake (moromi). The acidity is defined as titratable acidity with 0.1 N NaOH. In the present invention, a low alcohol concentration means alcohol concentration below 10%. Alcohol concentration of unrefined sake (moromi) can be adjusted by adjusting acidity and saccharification activity by means of mixing the raw materials, temperature control and controlling the number of days for fermentation.

Blending ratio of turbid unrefined sake (moromi) and clear transparent sake is preferably 1 to 10-30 from the standpoint of turbidity, sparkling and flavor. Filter can be a filter cloth and others. Inner gas pressure within the sealed vessel or tank by fermentation is set to 2-5 kg/cm² from the standpoint of balance of flavor. Fermentation temperature and term within the sealed vessel or tank are preferably from 5 days to 2 weeks at 6° C.-10° C., most preferably about 2 weeks at 10° C. Pasteurization is performed preferably 60° C.-65° C. from the standpoint of sparkling and flavor. Termination of the fermentation can preferably be made by lowering temperature to inactivate yeast or by pasteurization.

Filtration of the fermented liquid in the sealed tank under closed system is preferably performed by adding filter aid. Embodiment of the filter aid is, for example, diatomaceous earth which is generally used in the production process of Japanese sake. Other embodiments of the filtration are centrifugation using centrifuge or a combination of filtration and centrifugation. In the use of centrifuge, continuous centrifuge is most preferable.

Mash of the Japanese sake having low alcoholic content and superior flavor and taste can be produced by saccharification and fermentation of the steamed rice and malted rice (koji) in the presence of multiple acids. A part of the unrefined sake (moromi) is filtered through coarse filter or is centrifuged to prepare turbid liquid containing yeast with fermentation activity. The remaining other part of unrefined sake (moromi) is pressed to separate clear transparent liquid. The thus obtained turbid liquid and clear transparent liquid are blended, poured into the vessel or closed tank and sealed, then are fermented. The fermentation is progressed in the sealed vessel or tank and carbon dioxide gas is generated. As a result, sake having sparkling nature with refreshing taste and superior flavor with low turbidity can be produced.

In the case that the fermentation proceeds in the sealed tank, clear transparent filtrate can be obtained by filtering the fermented liquid in the sealed tank. In the filtration performed under the system of sealed condition, dispersion of carbon dioxide can be prevented as well as preventing decrease in flavor. As a result, clear transparent, sparkling, refreshing feeling and superior flavoring sake can be produced.

The thus produced sake has balanced refreshing feeling and flavor. Especially, the product sake having alcohol content 4-6%, Japanese sake scaling between −70 and −90, acidity 3-4, and gas pressure in the vessel 2-5 kg/cm² is most preferable in its refreshing feeling and flavor nature. Further, the product sake having absorbancy at 660 nm between 0 and 2.0 does not give cloudy on the glass wall after drinking up using a glass. The product sake having absorbancy at 660 nm between 0 and 0.01 is observed visually to be clear transparent without turbidity.

### Embodiment 1

Lactic acid 800 ml was added to water 181 L. Yeast strain Kyokai No. 901, malted rice (koji) 5 kg and steamed rice 95 kg were added therein and the resulting unrefined sake (moromi) was prepared to the working condition at 40° C.

After 10 days of fermentation, a part of unrefined sake (moromi) was filtered through the filter cloth of about 160-210 mesh, and the remaining unrefined sake (moromi) was press-filtered.

The turbid liquid which was filtered through filter cloth and the clear transparent liquid prepared by compressed filtration were mixed and blended and added water thereto for adjusting the components. The mixture was bottled in capacity 300 ml glass and sealed, then fermented at 6° C.-10° C. Gas pressure in the bottle at 10° C. reached 2-5 kg/cm², the temperature was kept at −5° C. to terminate the fermentation. Gas pressure was measured by a gas pressure gauge. After storing at −5° C. for 5 days, pasteurization was conducted at 60° C.-65° C. Then the sparkling low alcoholic beverage sake was produced.

The thus produced sparkling low alcoholic beverage sake was tested by organoleptics. Tests were performed on the produced sparkling low alcoholic sake and 5 commercially available sparkling sake, in total 6 samples by panelists of 11 specialists. Evaluation was indicated by mean value taken by the panelists according to the results giving numbers from 1 to 6 depending on preferable flavor without indicating trade name. Results are shown in Table 1.

As shown in Table 1, the evaluation in the sparkling low alcoholic sake in embodiment 1 is the highest, and is found to have the superior flavor. A coefficient of concordance W by Kendall was calculated to examine the concordance of the evaluations. As a result, the coefficient of concordance W was significant at significance level 1%. Consequently, judgement provided by the panelists highly coincided.

TABLE 1

| | A Co. | B Co. | C Co. | D Co. | E Co. | Embodiment 1 |
|---|---|---|---|---|---|---|
| Type | Honjozo | Junmai | Junmai | Honjozo | Junmai | Junmai |
| Capacity Vol. (ml) | 180 | 300 | 300 | 300 | 360 | 300 |
| Alcohol content | 12.6% | 5.2% | 6.0% | 14.3% | 17.9% | 5.1% |
| Japanese sake scaling | +4.5 | −45.0 | −18.5 | +4.5 | +10.0 | −77.5 |
| Acidity | 1.10 | 1.90 | 2.79 | 1.69 | 2.00 | 3.90 |
| Amino acid | 0.40 | 0.61 | 0.25 | 0.65 | 1.15 | 0.30 |
| Evaluation | 2.3 | 5.0 | 4.5 | 3.3 | 4.9 | 1.1 |

* Honjozo Sake is made from rice, malted rice and alcohol for brewing.
Junmai Sake is made from rice and malted rice.

Further the turbidity of the sparkling low alcoholic sake of the embodiment in which the organoleptic test was executed 1 and commercially available 5 samples of sparkling sake, in total 6 samples, were measured. Turbidity was measured by absorbancy at 660 nm by using spectrophotometer (Trade name: Shimadzu UV-visible light spectrophotometer UV-160A) and indicated by the order. Heavy turbid sample was measured after dilution. Results are shown in Table 2.

TABLE 2

| | A Co. | B Co. | C Co. | D Co. | E Co. | Embodiment |
|---|---|---|---|---|---|---|
| Dilution | 5 times | 10 times | 10 times | No dilution | No dilution | No dilution |
| Absorbancy (660 nm) | 1.684 | 1.332 | 1.937 | — | — | 1.100 |
| Turbidity (rank) | 3 | 2 | 1 | Transparent | Transparent | 4 |

As shown in Table 2, turbidity of the sparkling low alcoholic sake of the embodiment 1 is the fourth among the 6 samples tested, and is the lowest turbidity among the low alcoholic content below 10%. The products of B Company and C Company remained turbidity on the glass wall after drinking up, but no turbidity was observed on a wall of a glass in the sparkling low alcoholic sake of the embodiment 1.

### Embodiment 2

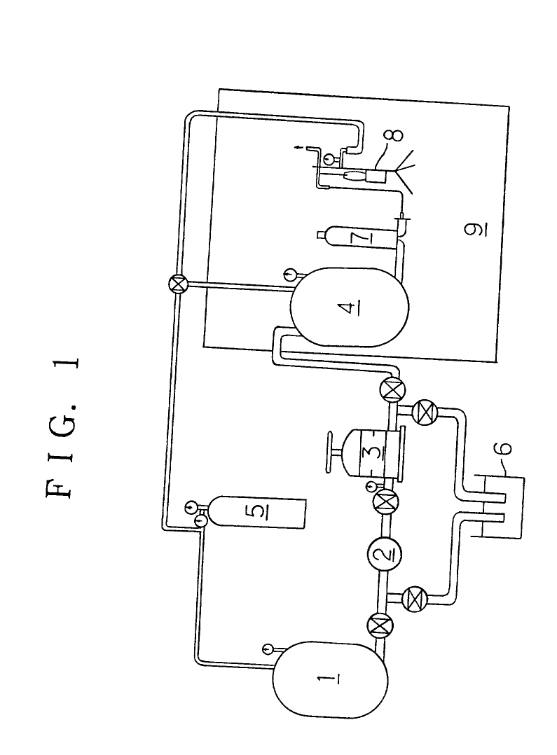

An embodiment 2 will be explained by referring to FIG. 1.

Lactic acid 800 ml was added to water 181 L. Malted rice 5 kg and steamed rice 95 kg were added thereto and saccharified at about 40° C. After completing the saccharification, the mixture was cooled to 30° C. or lower and yeast strain Kyokai No. 901 was added to prepare unrefined sake (moromi) to the working condition.

After 10 days of fermentation, a part of fermented unrefined sake (moromi) was filtered through filter cloth of 160-210 mesh, and the remaining unrefined sake (moromi) was compress filtered. The cloth filtered turbid liquid and compress filtered clear transparent liquid were mixed and blended, and water was added to adjust components. The process thereafter proceeded by using the equipment plant shown in FIG. 1.

As illustrated in FIG. 1, a sealed tank 1 is connected to storage tank for sake 4 through sanitary dry pump 2 and filter press 3. Carbon dioxide gas cylinder 5 is connected to the sealed tank 1 and the storage tank for sake 4, and between the sealed tank 1 and the storage tank for sake 4, a precoat vessel 6 is provided in parallel with the sanitary dry pump 2 and the filter press 3. A bottling machine 8 is connected to the storage tank for sake 4 through membrane filter device 7. To the bottling machine 8, the carbon dioxide gas cylinder 5 is connected in order to fill up carbon dioxide gas into bottles during the bottling operation. The storage tank for sake 4, membrane filter device 7 and bottling machine 8 are set in the cold room 9 at −5° C. A route of liquid from the sealed tank 1 to the bottling machine 8 constitutes a closed system.

In the plant in FIG. 1, a mixture of the turbid liquid and the clear transparent liquid was poured into the sealed tank 1 and fermented at 10° C. The filter press 3 was previously precoated by means of the precoat vessel 6. When the gas pressure in the sealed tank 1 reached 2-5 kg/cm², the fermented liquid in the sealed tank 1 was suctioned by the sanitary dry pump 2 to filter through the filter press 3. The filtrate was stored in the storage tank for sake 4.

The liquid in the storage tank for sake 4 was further filtered through the membrane filter device 7 and the filtrated clear transparent liquid was bottled in capacity 300 ml glass by means of the bottling machine 8. The liquid content of the sealed tank 1 is transferred in the closed route for the filtration and bottling. After bottling, pasteurization was performed at 60° C.-65° C. Then the clear transparent sparkling low alcoholic beverage sake was produced. Absorbancy at 660 nm of the said sparkling low alcoholic beverage sake was 0.004. The thus produced sparkling low alcoholic beverage sake was stored at −5° C. for 5 days.

The thus produced sparkling low alcoholic beverage sake was tested by the organoleptics. In the organoleptics, comparative examples were prepared. A comparative example 1 was produced as follows: the clear transparent liquid obtained from compressed filtration of the unrefined sake (moromi) in the production of low alcoholic beverage sake in embodiment 2 was bottled in capacity 300 ml glass bottles using the bottling machine 8, pasteurized at 60 ° C.-65° C., and stored at −5° C. for 5 days. A comparative example 2 was produced as follows: the blend of the turbid liquid and clear transparent liquid in the production of low alcoholic beverage sake in this embodiment 2 was bottled in capacity 300 ml glass bottles in place of storage in the sealed tank 1. The fermentation was conducted at 6° C.-10° C. and at the time when the inner bottle gas pressure at 10° C. reached 2-5 kg/cm², it was terminated by keeping at −5° C., then stored at −5° C. for 5 days. The thus obtained liquid was pasteurized at 60° C.-65° C. and further stored at −5° C. for 5 days. Absorbancy of the thus prepared control product at 660 nm was 1.1.

The comparative example 1 is different in the point having no preparation for sparkling process and no filtration process in the closed system as compared with the sparkling low alcoholic beverage sake in this embodiment 2. The comparative example 2 is different in the point having no filtration process in the closed system and fermenting in the bottle as compared with the sparkling low alcoholic beverage sake in this embodiment 2. The comparative example 2 corresponds to the low alcoholic beverage sake in embodiment 1.

The organoleptics were conducted by 6 panelists of the experts on the sparkling low alcoholic beverage sake of embodiment 2 and comparative examples 1 and 2. Evaluation was conducted 4 grades and is shown with mean value provided by panelists. Results are shown in Table 3. In Table 3, ⊚: excellent, ◯: good, Δ: fair, and ×: failed.

As shown in Table 3, evaluation of the sparkling low alcoholic beverage sake of the embodiment 2 is the highest and is understand to have superior flavor. The sparkling low alcoholic beverage sake of the embodiment 2 and a comparative example 1 have almost identical composition except for sparkling nature, however the beverage sake of embodiment 2 has good stimulative feeling due to sparkling in the mouth with spreading clearness and coolness owing to addition of carbon dioxide. The taste of sake quality is not limited within the base of sweetness and acidity but the carbon dioxide gas adds variety of tastes. Further, the operations totally progress within the closed system from the fermentation in the sealed tank to the bottling. As a result, not only the carbon dioxide gas but also the flavoring components are prevented from dispersing to the outside atmosphere, and refreshing and preferable flavor of the Japanese sake can be maintained. When the sparkling low alcoholic beverage sake of the present invention is filled in the glass, sparkling reminds of sparkling wine, which has further much to remind of the image of conventional Japanese sake.

TABLE 3

| | | Comparative | Comparetive | Embodiment |
|---|---|---|---|---|
| | | Example 1 | Example 2 | 2 |
| Taste | Refreshing | Δ | ⊚ | ⊚ |
| | Lightness and | ◯ | Δ | ⊚ |
| | Pleasantness | | | |
| | Smooth | ◯ | Δ | ⊚ |
| | Harmony | ⊚ | ◯ | ◯ |
| Flavor | Refreshing | Δ | ◯ | ⊚ |
| Quality | Difficulty to | ◯ | X | ◯ |
| maintenance | deterioration | | | |
| Visual | Clearness | Δ | Δ | ⊚ |

The sparkling low alcoholic beverage sake of the embodiment 2 and that of the comparative example 2 have almost identical compositions including sparkling nature but are different in the transparency. The product of the embodiment 2 gives fresh and clear impression in drinking as a result of removing turbidity. Namely, viscous feeling, heavy aroma and tasteless derived from starchy substance, which is major component of turbidity, have disappeared.

The product of the present invention is excellently pleasant taste and has clear-cut aftertaste. Since the product has no turbidity, bursting bubbles give clear fresh image, which can not be expected in the unrefined sake (moromi). The unrefined sake (moromi) has an image of product in winter season, but the product of the embodiment 2 is clear and transparent and is not limited to drink in atmosphere and season, and can be enjoyable in any places and seasons. The comparative example 2 is deteriorated to produce smell of sake lees during long time storage, but the product of the embodiment 2 does not produce sake lees smell due to deterioration. Consequently, removal of turbidity (impurities) from the product of the embodiment 2 prevents deterioration of flavor and taste and provides keeping for a long time.

According to the method of producing the sparkling low alcoholic beverage sake of the present invention, the sparkling low alcoholic beverage sake having low turbidity, high transparency, pleasant taste, easy drinking, harmonized superior flavor and refreshing taste, and visually clear transparency can be provided. Further, according to the process of the present invention, new type of Japanese sake with image of sparkling wine, which differs from conventional sake, can be provided. The young generation of the present days is said to appreciate low alcoholic sparkling beverages having smooth and fresh drinking taste such as beer. The development of the sparkling low alcoholic beverage sake of the present invention will provide the expanded demand of the young generation.

Note that the aforementioned disclosure claims the priority of and relates to the subject matter contained in Japanese Patent Application No. 10-377643 filed on Dec. 29, 1998, which is incorporated by reference in this application in its entirety.

1. A method of producing sparkling low alcohol content sake comprising the steps of:
saccharifying and fermenting steamed rice and malted rice (koji) in the presence of one or more acids to produce low alcohol content unrefined sake (moromi);
filtering said low alcohol content unrefined sake (moromi) with a coarse mesh filter, or centrifuging the same, so as to separate turbid liquid filtrate having fermentation activity containing yeast contained therein from a first clear liquid filtrate;
further separating a second clear liquid filtrate from the turbid liquid filtrate having fermentation activity containing yeast by compressed filtration of said turbid liquid filtrate;
blending the above turbid liquid filtrate and the first and second clear liquid filtrates obtained in the above two steps, to produce a fermentation liquid, in a sealed vessel within a closed system; and
fermenting the fermentation liquid.

2. The method of producing sparkling low alcohol content sake according to claim 1, wherein the fermentation is terminated when inner gas pressure in the sealed vessel produced by fermentation reaches 2-5 kg/cm².

3. The method of producing sparkling low alcoholic alcohol content sake according to claim 2, wherein pasteurization is conducted when the fermentation liquid in said sealed vessel reaches an alcoholic content of 4-6% vol./vol., Japanese sake scaling of between −70 and −90, and an acidity of 3-4 pH.

4. The method of producing sparkling low alcohol content sake according to claim 1, wherein said fermentation liquid is filtered within the closed system and the clear filtrate is sealed within the vessel when the said turbid liquid and the said clear liquid are blended and fermented in the sealed tank, and the fermented liquid in the said sealed tank reaches alcoholic concentration 4-6%, Japanese sake scaling between −70 and −90, and acidity 3-4 and inner gas pressure in the said sealed tank at 2-5 kg/cm².

5. The method of producing sparkling low alcohol content sake according to claim 4, wherein carbon dioxide is added into the said clear filtrate, when is then bottled.

6. A sparkling low alcohol content sake in the sealed vessel comprising having inner gas pressure of vessel 2-5 kg/cm², alcohol concentration 4-6%, Japanese sake scaling between −70 and −90, acidity 3-4 and absorbancy at 660 nm between 0 and 2.0.

7. The sparkling low alcohol content sake according to claim 6, wherein the absorbancy at 660 nm is in the range between 0 and 0.01.

8. The method of producing sparkling low alcohol content sake according to claim 1, wherein the turbid unrefined sake (moromi) and the first and second clear liquid titrates are blended in a blend ratio of from 1:10 to 1:30.

9. The method of producing sparkling low alcohol content sake according to claim 1, wherein fermentation is carried out for 5 days to 2 weeks.

10. The method of producing sparkling low alcohol content sake according to claim 1, wherein fermentation is carried out at a temperature of from 6° C. to 10° C.

11. The method of producing sparkling low alcohol content sake according to claim 1, wherein fermentation is carried out for 2 weeks at 10° C.

12. The method of producing sparkling low alcohol content sake according to claim 1, wherein the saccharifying and fermenting of steamed rice and malted rice (koji) is carried out in the presence of lactic acid.
